(19) United States
(12) Patent Application Publication
(10) Pub. No.: US 2014/0035240 A1
(43) Pub. Date: Feb. 6, 2014

(54) SLIDING SEAL FOR SEALING A JOINT IN A TURBINE CASING AND METHOD FOR SEALING

(71) Applicants: Karimulla Shaik SHA, Karnataka (IN); Sayed AHMED, Karnataka (IN); Vikram JAGANNATH, Karnataka (IN)

(72) Inventors: Karimulla Shaik SHA, Karnataka (IN); Sayed AHMED, Karnataka (IN); Vikram JAGANNATH, Karnataka (IN)

(73) Assignee: GENERAL ELECTRIC COMPANY, Schenectady, NY (US)

(21) Appl. No.: 13/566,527

(22) Filed: Aug. 3, 2012

(51) Int. Cl. F16J 15/02

(52) U.S. Cl. 277/641

(57) ABSTRACT

A seal and slot assembly for sealing joints between casings of a turbomachine including: a first slot in a first casing flange; a second slot in a second casing flange, wherein a joint is formed between the first casing flange and second casing flange and the first slot overlaps with the second slot; a chamber formed by the first slot and second slot, and a seal in the chamber and configured to slide with respect to at least one surface of the first slot and the second slot due to gas pressure in the chamber.

### BACKGROUND OF THE INVENTION

The invention relates generally to gas blocking seals at joints between metal casings for turbomachinery, and particularly to seals between outer casings for turbines that prevent leakage of pressurized gases.

FIG. 1 illustrates a portion of a conventional industrial gas turbine 10 having a compressor 12, turbine 14 and an array 16 of combustor cans. These components 12, 14, 16 are housed in outer casings of the gas turbine. The compressor is housed in a stator casing 18, the array of combustor cans is housed in a combustion wrapper (casing) 20, and the turbine is housed in a turbine casing 22. Further each combustor can include a combustor casing 24.

High pressure working gases are generated in the gas turbine and flow through gas passages in the compressor, combustor cans and turbine. The high pressure working gas, which includes compressed air and gases generated by combustion, generate heat and raise the temperatures of the components of the gas turbine. In a steam turbine, the high pressure gases may be steam. The high pressure gases are substantially above atmospheric pressures and are confined to the gas turbine by the outer casings.

Joints in the outer casings are potential sources of leaks of the pressurized gases. The joints may extend circumferentially around all or a portion of the compressor and array of combustion cans; between the outer cylindrical casings for each combustion can and the outer casing for the compressor, and between the combustion wrapper and the stator casing. Other joints may extend axially such as between an upper segment and a lower segment of the casing for the compressor. The combustion wrapper may also be formed of upper and lower segments, with a horizontal joint between the segments.

The joints 26 between casings or segments of a casing are typically formed where a flange on one casing abuts against an adjacent flange of another casing. For example, the combustion wrapper has one end with a circumferential flange that abuts against a circumferential flange of the casing for the compressor. The opposite end of the combustion wrapper has a circumferential flange that abuts against a circumferential flange of the turbine casing. Similarly, the cylindrical housings for each of the combustion cans may have a flange at the end that joins to the compressor casing.

To prevent leaks of cooling gases through the casings, the flanges have flat surfaces to seat on opposing flat surfaces of the flanges on the other side of a joint. The flanges are held together by bolts arranged in an array along the flange. The bolts extend through the flanges to join the casings together. A seal between the opposing surfaces forming a joint also prevents leakage, of pressurized gas. The seals have conventionally been metallic rings, labyrinth grooves and deformable materials.

The flat flange surfaces, bolts and seals may not completely prevented leakage of cooling gases through the joints in the casings of compressors, combustion wrappers and combustion cans. Due to the extreme temperatures occurring in a gas or steam turbine, the metallic casings of the turbine undergo substantial thermal expansion and contraction which result in leaks forming in the joints between casings. Accordingly, there remains a long felt need prevent leakage of gases from the casings of gas and steam turbines, and other turbo-machinery.

### BRIEF DESCRIPTION OF THE INVENTION

A seal assembly has been conceived for sealing segments a combustor wrapper of a turbine comprises a first horizontal flange provided on a first segment of the combustor wrapper and a second horizontal flange provided on a second segment adjacent the first segment; a first slot provided in the first flange and a second slot provided in the second flange, the first and second slots extending axially along the first and second flanges, respectively; and a sliding seal provided in the first and second slots, the seal extending axially along the slot and being configured to engage at least one edge of the first slot and the second slot by pressure in the combustor wrapper.

A seal and slot assembly has been conceived for sealing joints between casings of a turbomachine, the assembly comprising: a first slot in a first casing flange; a second slot in a second casing flange, wherein a joint is formed between the first casing flange and second casing flange, and the first slot overlaps at least partially with the second slot when the joint is formed; a chamber formed by the first slot and second slot and extending across the joint, and a sliding seal in the chamber and configured to slide with respect to at least one surface of the first slot and the second slot due to gas pressure in the chamber. The seal and slot assembly may be for a gas turbine and the casings are at least one of a combustion wrapper, a stator casing and a combustion can casing.

The seal may comprise a first metal seal section and a second metal seal section, and the first metal seal section includes a first inclined surface and the second metal seal section includes a second inclined surface, wherein the sliding engagement occurs between the first and second inclined surfaces. Further, a tongue may extend from the first inclined surface and a groove in the second inclined surface, wherein the tongue slides in the groove in a direction of the sliding engagement.

The first inclined surface may be at a positive or negative incline from a front face of the first metal seal section to a backside of the first metal seal section. The first and second inclined surfaces may be each planar surfaces. The second metal seal section may be fixed to the second slot and the first metal seal section slides within the chamber. The first flange may comprise at least one of a gas passage extending from the joint or a gas passage extending from the inner surface (high pressure side) of the flange to the chamber facing a front face of the first metal seal section. At least one flexible seal may exist between the metal seal and a wall of one of the first or second slots. The metal seal may be formed of stainless steel or carbon steel. A coating on the metal seal on the sliding surface has a lower coefficient of friction than the principal material forming the seal. The coating may be formed of a low friction metal treatment such as chrome, ceramic liner, resin-bonded dry lubricant, or moly and graphite lubricants.

A seal assembly for sealing segments an outer casing of a gas turbine comprising: a first flange provided on a first segment of the outer casing and a second flange provided on a second segment adjacent the first segment; a first slot provided in the first flange and a second slot provided in the second flange, the first and second slots extending axially along the first and second flanges respectively, and a sliding seal provided in the first and second slots, the seal extending axially along the slot and configured to engage at least one edge of the first slot and the second slot by pressurize gas in the combustor wrapper.

A method to seal a joint in a casing of a gas turbine, the method comprising: seating a seal in a chamber formed by adjacent slots in opposing flanges of the casing, wherein the joint extends through the chamber; applying force to a front of the seal due to pressurized gas leaking through the joint and entering the chamber; sliding the seal in the chamber by the application of the force of the pressurized gas; abutting the seal against a wall or edge of the chamber by the application of the force of the pressured gas to the front of the seal, and blocking by the seal the pressurized gas from leaving the chamber and entering the joint.

### BRIEF DESCRIPTION OF THE DRAWINGS

FIG. 1 is a perspective view of a conventional gas turbine, showing the casings of the turbine in partial cross-section.

FIG. 2 is a perspective view of a conventional combustion wrapper.

FIG. 3 is a cross-section view of a horizontal flange joint in the combustion wrapper shown in FIG. 2.

FIG. 4 is an exploded assembly view of a sliding split metallic seal.

FIG. 5 is a cross-sectional view of a sliding split metallic seal.

FIGS. 6 to 8 are cross-sectional views of embodiments of sliding split metallic seals in different configurations of slots within the flanges.

FIGS. 9 to 12 are cross-sectional views of embodiments of a non-split sliding metal seals in slots of flanges.

FIGS. 13 to 16 are cross-sectional views of embodiments of sliding metal seals having a deformable seal(s) between the seal and walls of the slots.

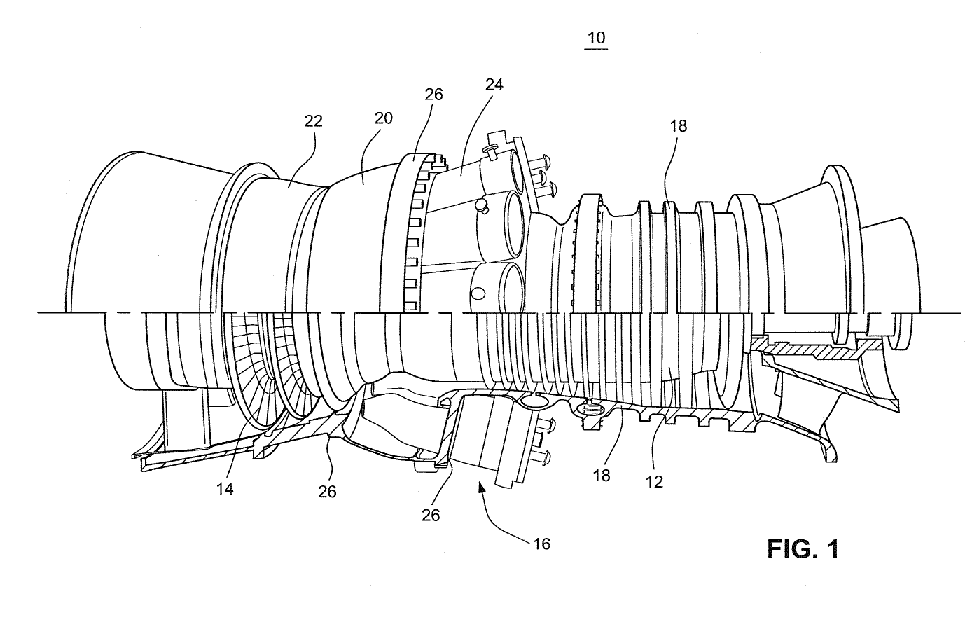

### DETAILED DESCRIPTION OF THE INVENTION

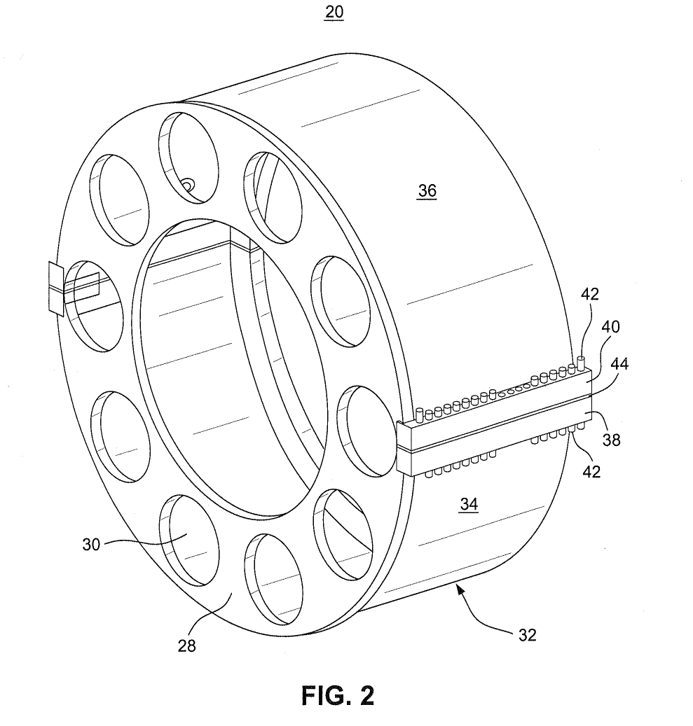

FIG. 2 shows a conventional combustion wrapper 20, which is an exemplary casing of a turbine. The combustion wrapper provides an outer housing with an annular support plate 28 with openings 30 for the combustion cans. The combustion wrapper also includes a cylindrical section 32 that houses the combustion gas ducts extending from the combustion cans to the turbine. The cylindrical section is split into a lower casing segment 34 and an upper casing segment 36. The upper and lower casing segments shown in FIG. 2 are an example of the various types of outer casings on a turbine.

The upper and lower casing segments 34, 36 have ends with horizontal flanges 38, 40 that extend the length of their segment. The flanges each have a surface configured to abut against a surface on an opposing flange. The flanges are clamped together by fasteners such as bolts 42. The blots hold together the opposing surfaces of the flanges. A longitudinal joint 44 is between the flanges and extends the length of the casing segments 34, 36. The flanges 38, 40 and joint 44 is exemplary of flanges and joints between various casings and segments of casings in a turbine. The flanges and joints may extend longitudinally as shown in FIG. 2 or may extend in a full or partial circle such as a joint between an casing of a combustion can and the annular plate 28 of the combustion wrapper.

Using flanges and bolts to fasten together casings in a gas turbine is conventional. The opposing surfaces of the flanges may be machined to match each other and allow for no or nominal gaps in the joint between the surfaces when the casings are bolted together. The bolts may be arranged in such numbers that they tightly clamp together the opposing surfaces of the flanges.

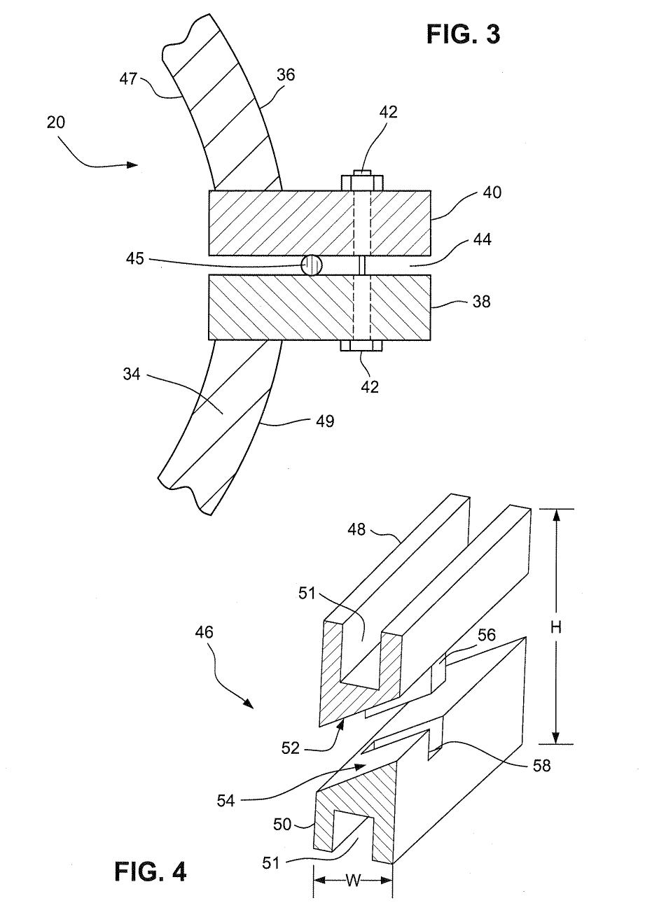

FIG. 3 is a cross-sectional view of the joint 44 between the horizontal flanges 40, 38 of the combustion wrapper 20. The flanges have opposing planar surfaces that extend the length the of the combustion wrapper. The opposing planar surfaces are clamped together by the bolts 42. The planar surfaces may include slots for seals 45. The inner surfaces 47 of the combustion wrapper form a chamber(s) for pressurized gasses. The outer surfaces 49 of the combustion wrapper may be exposed to air at atmospheric pressure.

While matching flange surfaces, bolts 42 clamping the flanges together and conventional non-sliding seals 45, securely fasten together the segments of a casing or fastens casings, the joint between the segments or casings may leak pressurized gases that seep through narrow openings in the joint. A cause of leaks in the joints maybe the expansion and contraction of the casings due to transient thermal gradients. An approach to reducing or eliminating leaks is to increase the number of bolts arranged along a flange. While the flange to bolt stiffness for a casing may be well within the acceptable limits, design space limitations on the flanges and the size of the bolts can make adding bolts impractical. Moreover, simply adding bolts may not fully prevent gas leakages due to thermal gradients that deform the casings.

To enhance the sealing of the joints between casings and casing segments, a sliding seal has been conceived which is biased by gas pressure to form a gas tight seal in a joint between a casing or casing segments. The seal is seated in slots in the opposing surfaces of the flanges of the casings. The seal spans the joint between the casings. The seal slides within the slots to prevent gas leakage through the slot and joint. The ability to slide within the slot and joint allows the seal to block leaking gases and adjust to thermal expansion and contraction of the casings.

The seal may be a longitudinal split bar or an annular split ring having inclined surfaces between the split sections of the seal. The outer bar segment or ring slides over the inner bar segment or ring due to gas pressure applied to one side of the seal. As the bar segment or ring slides up or down the incline, the seal expands in height or width. The expansion of the seal increases the ability of the seal to prevent gas leakage through the joint between flanges.

The sliding seal, such as a split seal or solid seal, may be have a wedge cross-sectional shape. The slots in the flanges for the seal may form a matching wedged chamber for the wedged seal. As the seal slides under the force of gas pressure, the wedge seal slides into the narrowing space of wedged slots and the seal binds against the slots and blocks gas leaks through the joint.

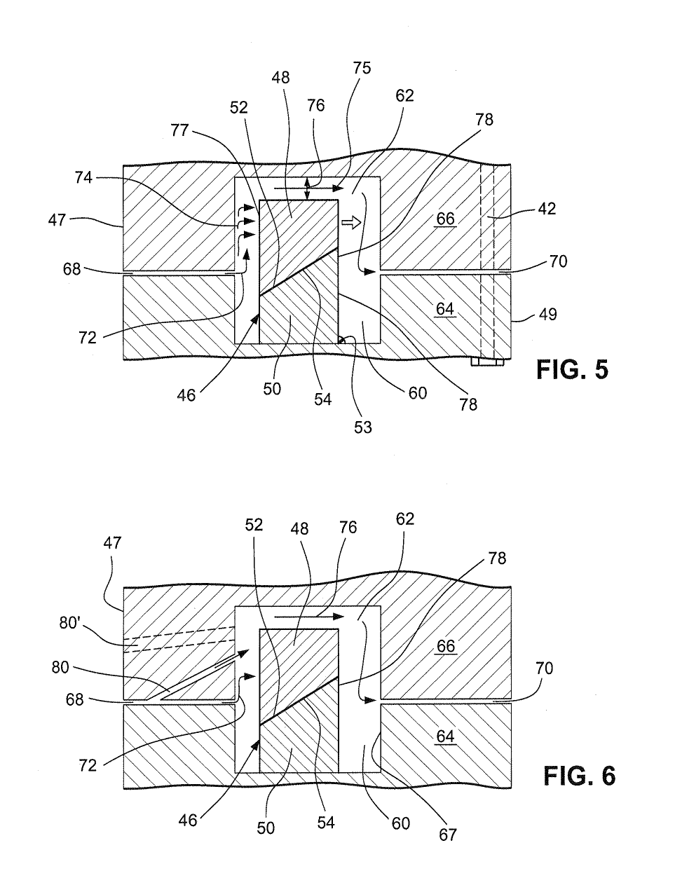

FIG. 4 is a perspective view of a portion of a split seal 46. The seal may be annular or linear depending on whether the joint into which the seal is to be seated is annular or longitudinal. The seal 46 may have other shapes to conform to a joint between the casings or segments of a casing. The seal may be metallic, such as carbon or stainless steel. The seal may also be formed of non-metallic materials, such as reinforced graphite and mica, and polyetheretherketone. The split seal may be arranged in slots 60, 62 (FIG. 5) in the flanges 66, 64 of a combustion wrapper. These slots may be between the high pressure of the casing and the bolts 42 extending through the flanges.

The seal 46 includes a first section 48 and a second section 50. The sections each extend generally parallel to the joint intended for the seal. The outer surfaces of the seals that abut against the slots in the flanges may be shaped to conform to the walls of the slots. For example, the bottom surface of the second section 50 may be planar if the seal is a longitudinal joint or straight in cross section if the seal is for an annular joint.

The split seal sections 48, 50 have opposing surfaces 52, 54 that are inclined with respect to a plane defined by the joint. The matching inclined surfaces 52, 54 cause the width (W) or height (H) of the seal 46 to increase as the first section 48 slides over the second section 50. The expansion of the seal due to sliding increases the gas blocking function of the seal. Because gas pressure is used to slide one section 48 with respect to the other 50, it is the gas pressure of the potentially leaking gas that increases the gas blocking function of the seal. Leaking gas is used to enhance the seal to prevent gas leakage through the seal.

The seal sections 48, 50 may have alignment devices such as a tongue 56 and groove 58 arranged at one or more locations along the length or circumference of the seal 46. The tongue 56 seats in the groove 58 to ensure that the first section 48 of the seal remains aligned and in contact with the second section 50. The tongue 56 slides in the groove as the first seal section 48 slides against the second seal section. The front of the groove may be closed (as shown in FIG. 3) to prevent the first seal section 48 sliding too far forward of the second seal section 50. In the example shown in FIG. 3, the rear of the groove is not closed but in another embodiment the rear of the groove may be closed to prevent excessive movement of the first seal section over the second seal section.

The seal sections 48, 50 may be hollow as indicated by chambers 51. A hollow seal section has a low mass and slides easier as compared to a more massive section.

FIG. 5 shows a cross-section of the split seal 46 seated in opposing slots 60, 62 of opposing flanges 64, 66 that form a joint 68, 70. The seal section 50 may be attached to the bottom of the slot 60 by a bolt (not shown) extending through the seal section or a weld 53 between the bottom of the seal section and the bottom of the slot. A portion 68 of the joint is near the inside 47 of the casing associated with the flanges and the portion 70 is near the outer surface 49 of the casing. To the extent gaps are in the joint, pressurized gases 72 can leak into the joint 68. As the leaking gases enter the open volume of formed by the opposing slots 60, 62, the pressurized gases apply gas pressure 74 to the front 77 of the split seal 46. Because the gap 76 is narrow between the walls of the slots and the split seal, the pressure of the leaking gases at the backside 78 of seal is substantially lower than the pressure 74 on the front 77 of the seal.

The difference in gas pressure on the front 77 of the seal and on the back 78 of the seal can be sufficient to slide the first section 48 of the seal over the second section 50 of the seal. By way of example, it is estimated that the static gas pressure on the front of the seal may be in a range of 135 to 162 pounds per square inch (psi) with the static gas pressure on the backside of the seal is in a range of 98 to 33 psi before the seal sections 48, 50 shift to enhance their sealing function. Once the seal function is performing as intended, the pressure on the backside of the seal falls to substantially atmospheric pressure, e.g., 14.7 psi. Once the pressure on the backside 78 falls, the high pressure difference across the seal sections 48, 50 continues to bias the seal sections in an expanded sealing arrangement.

A determination may be made as to the threshold difference in gas pressures acting on the front and back of the seal. The threshold difference corresponds to the minimum leakage level that will cause the first section 48 to slide over the second section 50, or to cause the seal to slide over a surface of the slots. Knowing the threshold difference and the surface areas of the front and backsides of the seal and the coefficient of friction, a calculation can be made to determine the optimal the incline (slope) of the opposing surfaces 52, 54 in the seal 46. An exemplary calculation is below:

$$cos ( θ ) = \frac{ForceOnFrontFace}{μ mg}$$

Where θ is the angle of the incline, the ForceOnFrontFace is the force on the front face of the first section 48 due to the gas leakage pressure difference across the seal 46, μ is the coefficient of friction of the surfaces 52, 54, m is the mass of the first section 48 and g is the gravitational constant. By calculating θ, the incline of the split seal 46 can be determined when designing the seal.

By selecting materials for the surfaces 52, 54 having a low coefficient of friction, the threshold force or pressure needed to cause the sections 48, 50 to slide with respect to each other can be reduced to ensure that the sections slide when a gas leak seeps through the joint between the flanges. The surface 52, 54 may be coated to reduce the coefficient of friction such as chrome, a ceramic liner, a resin bonded dry lubricant and moly or graphite lubricants. Similarly, the threshold force or pressure may be reduced by minimizing the mass of the first section 48 of the seal. The mass may be minimized by selecting materials for the first section that have low density and by making the seal section hollow 51 (FIG. 4).

FIG. 6 shows the split seal 46 in the slots 60, 62 of the flanges 64, 66. The flange 66 as shown in FIG. 6 has a gas path 80 that extends from the inside portion 68 of the joint towards the front face of the first section 48 of the seal 46. The gas path 80 allows gases that have leaked at least partially through the inside portion 68 of the joint to be directed to the front of the seal. The gas path 80′ may extend from the inner surface 47 of the casing directly to the slot 60, 62. The gas path allows sufficient leaking gases to cause the seal 48 to shift and expand to ensure that gases do not leak past the seal and reach the outside portion of the joint 70. The gas path 80′ may be several narrow passages arranged symmetrically along the length of the inside portion of the joint.

If and when pressurized gas leaks through the inside portion 68 of the joint and creates more than a threshold pressure difference across the split seal 46, the pressure difference pushes the first seal section 48 up the incline formed by the abutting surfaces 52, 54. As the first seal section slides up the incline which increases the height of the seal 46. As the height increases, the gap 76 narrows between the top or bottom of the slots 60, 62 in the flanges. As the gap narrows, the volume is reduced of gas 75 leaking past the seal 46 and the gas leakage may be stopped. The gas pressure remains on the front of the seal 46 and continues to force the first seal section 48 up the inclined surfaces between the first and second sections of the seal. But for the sealing function of the seal sections 46, 48, the leaking gas would flow past the seal 46, reach the back face 67 of the slot 66, and leak through the joint 70.

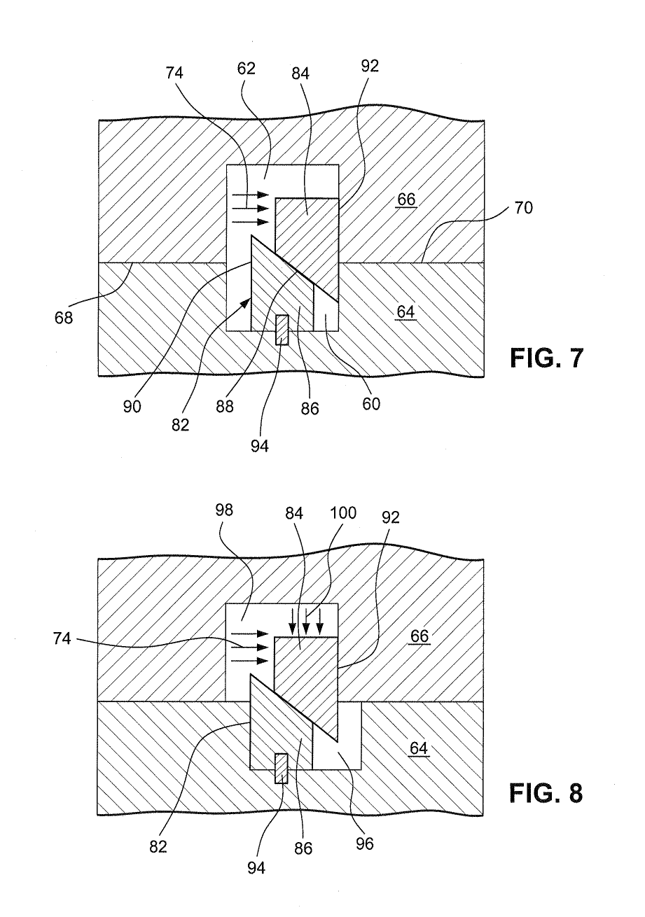

FIG. 7 shows another example of a split seal 82 having a first section 84 and a second section 86, similar in many respects to the split seal 46. The incline 88 between the abutting surfaces on the first and section sections 84, 86 has a downward slope from front 90 to back 92 of the seal section 84. As pressurized gas leaks through the inside portion 68 of the joint and enters the chamber formed by the slots 60, 62, the gas pressure 74 on the front 90 of the seal slides the first section 84 down over the second section 86 until the back 92 of the second section abuts against the walls of the slots 60, 62. The abutment seals the entrance to the outside portion 70 of the joint and prevents the leakage of gas beyond the seal 82. The sliding of the first section 84 down across the second section 88 expands the width of the seal 82 and reduces or eliminates the gap between the seal and the walls of the slots. The gas pressure on the front 90 of the seal continues to bias the first section 84 against the back wall of the slots.

A tab 94, rib, bolt, weld or other securing device locks the position of the second 86 with respect to the slot 60. The tab seats in a groove in the bottom of the second section 86 and the floor of the slot 60. The tab prevents the second section from moving while the first section 84 is sliding and is being biased against the back wall of the slot.

FIG. 8 shows the seal 82 in an alternative arrangement of slots 96, 98 in the opposing flanges 64, 66. The slots 96, 98 are offset in their alignment. The offset allows the first section 94 to abut solidly against the back wall 92 of the upper slot 98 and extend freely into the lower slot 96. By allowing the first section to extend into the lower slot, the first section 94 can be pushed against the slot wall 92 by gas pressure 74, 100 applied to and the front and top of the seal.

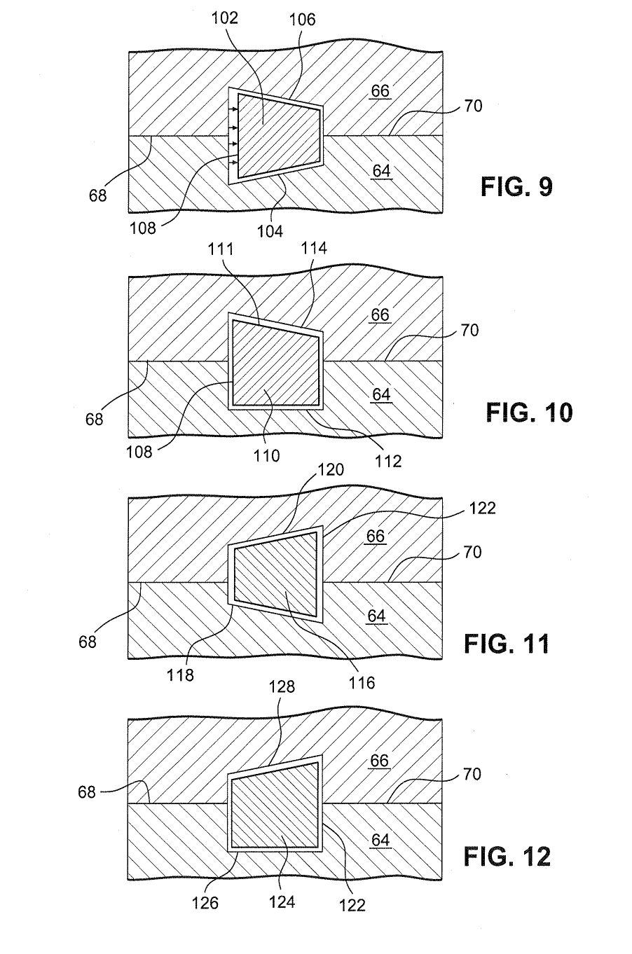

FIGS. 9 to 12 illustrate various embodiments of a seal that need not be split but has a wedge cross-sectional shape. A seal 102 with a trapezoidal cross-section is seated in a pair of slots 104, 106 forming a trapezoidal chamber for the seal. The chamber is slightly longer than the width of the seal. As leakage gas pressure builds up on the front surface 108 of the seal, the seal slides back into the chamber and binds against the upper and lower walls of the chamber to form a gas-tight seal that prevents gas leaking into the outer portion 70 of the joint.

The seal 110 in FIG. 10 has at least one sloping surface 111 and is seated in a chamber defined by slots 112, 114. The slot wall adjacent the sloping surface 111 of the seal has a similar slope. As gas pressure against the front of the seal slides the seal back, the sloping surface 111 of the seal binds against the sloping wall of the chamber and creates a gas-tight seal between the seal and the walls of the chamber that prevents gas leakage into the outer portion 70 of the joint.

In another embodiment, the non-split seal 116 may have a trapezoidal cross section that is narrow towards the inner surface of the casing (inner portion 68 of joint) and widens towards the outer portion 70 of the joint. The slots 118, 120 form a chamber having a trapezoidal cross-sectional shape similar to that of the wedge. Pressure from leakage gas passing through the inner portion 68 slides the seal back against the back wall of the slots 118, 120 to prevent gas leaking into the outer portion 70 of the joint. Another non-split seal 124 has a cross-sectional shape with at least one side having a slope similar to the slope of a top or bottom wall of one of the slots 126, 128. The slope increases the height of the seal from the front to the back of the seal. As gas pressure pushes on the front of the seal 124, the seal slides to abut against the back wall 122 of the chamber and prevent gas leakage into the outer portion 70 of the joint. As shown in FIGS. 8 to 11, a single seal having a variety of non-rectangular shapes may be seated in slots defining non-rectangular chambers. While these single piece seals may not expand in height or width as the seals shown in the earlier figures and thus may not provide as effective gas sealing as the split seals, the sliding seals 102, 110, 116 and 124 can provide effective seals to prevent leakage of pressurized gases from a joint of a casing in a gas turbine.

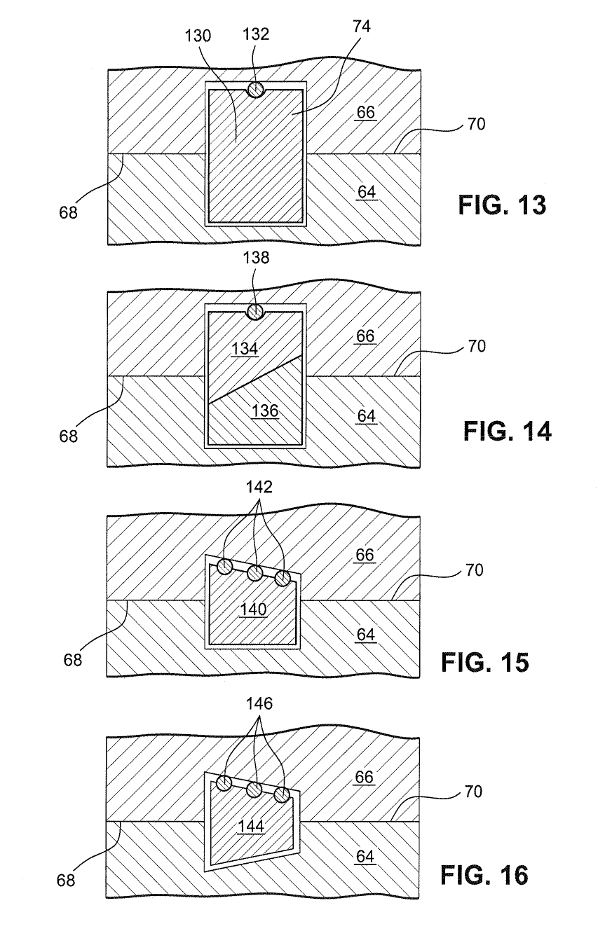

FIGS. 13 to 16 show single piece seals 130, 140 and 144 and a split seal 134, 136 seated in slots of opposing flanges 66, 64. These seals are similar in most respects to the various seals shown in the earlier figures. These seals have an additional component of a deformable seal, such as a flexible rod, rope, cord, tube or other thin component 132, 138, 142, 146 that is squeezed between an upper or lower surface of the seal and a top or bottom surface of the slots. There may be a single deformable seal 132 and 138 extending the length of the seal or a row of deformable seals 142, 146 each extending the length of the seal. The deformable seals enhance the sealing between the seal and the walls of the chambers and thereby assist in preventing leakage of pressurized gas from the turbine casing. The deformable seals do not prevent the sliding of the seal in the chamber or the internal sliding of the split seal.

While the invention has been described in connection with what is presently considered to be the most practical and preferred embodiment, it is to be understood that the invention is not to be limited to the disclosed embodiment, but on the contrary, is intended to cover various modifications and equivalent arrangements included within the spirit and scope of the appended claims.

What is claimed is:

1. A seal and slot assembly for sealing joints between casings of a turbomachine, the assembly comprising:
a first slot in a first casing flange;
a second slot in a second casing flange, wherein a joint is formed between the first casing flange and second casing flange and the first slot overlaps with the second slot;
a chamber formed by the first slot and second slot, and
a seal in the chamber and configured to slide with respect to at least one surface of the first slot and the second slot due to gas pressure in the chamber.

2. The seal and slot assembly of claim 1 wherein the seal and the chamber are between a pressurized gas region within the casings and fasteners extending through the first and second casing flanges.

3. The seal and slot assembly of claim 1 wherein the seal is hollow or has a sliding surface coated with a material with a low coefficient of friction.

4. The seal and slot assembly of claim 1 wherein the seal and chamber are linear or annular.

5. The seal and slot assembly of claim 1 wherein the seal comprises a first metal seal section and a second metal seal section, and the first metal seal section includes a first inclined surface and the second metal seal section includes a second inclined surface, wherein the sliding engagement occurs between the first and second inclined surfaces.

6. The seal and slot assembly of claim 5 further comprising a tongue extending from the first inclined surface and a groove in the second inclined surface, wherein the tongue slides in the groove in a direction of the sliding engagement.

7. The seal and slot assembly of claim 5 wherein the first inclined surface is at a positive incline from a front face of the first metal seal section to a backside of the first metal seal section.

8. The seal and slot assembly of claim 5 wherein the first inclined surface is at a negative incline from a front face of the first metal seal section to a backside of the first metal seal section.

9. The seal and slot assembly of claim 5 wherein the first and second inclined surfaces are each planar surfaces.

10. The seal and slot assembly of claim 5 wherein the second metal seal section is fixed to the second slot and the first metal seal section slides.

11. The seal and slot assembly of claim 1 wherein the first flange comprises at least one gas passage extending from the joint to a surface of the chamber facing a front face of the seal.

12. The seal and slot assembly of claim 1 further comprising at least one deformable seal between the metal seal and a wall of one of the first or second slots.

13. The seal and slot assembly of claim 1 wherein the seal includes a material from a group consisting of stainless steel, carbon steel, reinforced graphite and mica and polyetheretherketone.

14. A seal assembly for sealing segments of a combustion wrapper casing of a gas turbine comprising:
a first horizontal flange provided on a first segment of the outer casing and a second horizontal flange provided on a second segment adjacent the first segment;
a first slot provided in the first horizontal flange and a second slot provided in the second horizontal flange, the first and second slots extending axially along the first and second horizontal flanges respectively, and
a sliding seal provided in the first and second slots, the metal seal extending axially along the slot and configured to engage at least one edge of the first slot and the second slot by air pressure in the combustor wrapper.

15. The seal and slot assembly of claim 14 wherein the sliding seal comprises a first metal seal section and a second metal seal section, and the first metal seal section includes a first inclined surface and the second metal seal section includes a second inclined surface, wherein the sliding engagement occurs between the first and second inclined surfaces.

16. The seal and slot assembly of claim 15 further comprising a tongue extending from the first inclined surface and a groove in the second inclined surface, wherein the tongue slides in the groove in a direction of the sliding engagement.

17. The seal assembly of claim 15 wherein the first and second inclined surfaces are each planar surfaces and coated with a material having a lower coefficient of friction than a metal material forming the seal.

18. The seal assembly of claim 15 wherein the second metal seal section is fixed to the second slot and the first metal seal section slides within the chamber.

19. The seal assembly of claim 14 further comprising at least one flexible seal between the seal and a wall of one of the first or second slots.

20. A method to seal a joint in a casing of a gas turbine, the method comprising:
seating a seal in a chamber formed by adjacent slots in opposing flanges of the casing, wherein the joint extends through the chamber;
applying force to a front of the seal due to pressurized gas leaking through the joint and entering the chamber;
sliding the seal in the chamber by the application of the force of the pressurized gas;
abutting the seal against a wall or edge of the chamber by the application of the force of the pressured gas to the front of the seal, and blocking by the seal the pressurized gas from leaving the chamber and leaking out of the casing.

21. The method of claim 20 wherein the seal comprises a first metal seal section and a second metal seal section, and the first metal seal section includes a first inclined surface and the second metal seal section includes a second inclined surface, and the sliding step includes sliding between the first and second inclined surfaces.

22. The method of claim 20 wherein the abutting step includes a backside of the first metal seal section abutting against a wall of the chamber.
